(19) United States
(12) Patent Application Publication
(10) Pub. No.: US 2007/0162922 A1
(43) Pub. Date: Jul. 12, 2007

(54) Apparatus and method for processing video data using gaze detection

(76) Inventor: Gwang-Hoon Park, Seongnam-si (KR)

Correspondence Address: SUGHRUE MION, PLLC, 2100 PENNSYLVANIA AVENUE, N.W., SUITE 800, WASHINGTON, DC, 20037, US

(21) Appl. No.: 10/553,407

(22) PCT Filed: Nov. 2, 2004
(86) PCT No.: PCT/KR04/02794

§ 371 Date: Jan. 29, 2007

(30) Foreign Application Priority Data
Nov. 3, 2003 (KR) 10-2003-0077328

(51) Int. Cl. H04N 7/16; G06K 9/40; H04H 9/00; G06F 13/00; G06K 9/00; H04N 5/445; G06F 3/00

(52) U.S. Cl. 725/10; 725/1; 725/135; 725/38; 382/118; 382/254; 382/181

(57) ABSTRACT

An apparatus and method for processing video data using gaze detection are provided. According to the apparatus and method, the position of an area-of-interest which a user gazes at in a current image being displayed is detected and the area-of-interest is scalably decoded to enhance the picture quality such that the work load to the decoder can be reduced and the bandwidth limit of a data communication channel can be overcome.

### TECHNICAL FIELD

The present invention relates to an apparatus and method for processing video data, and more particularly, to a video data processing apparatus and method capable of improving the picture quality of an area-of-interest of a user in an image being displayed by using gaze detection.

### BACKGROUND ART

The video data coding technology of the past had been limited to compressing, storing and transmitting video data, but today's technology is focused on the mutual exchange of video data and providing user interaction.

For example, the video compression technology of MPEG-4 Part 2, which is one of international standards for video compression technologies, adopts a coding technique in units of video object planes (VOPs) in which data in an image frame are coded and transmitted in units of digital contents contained in the frame. FIG. 1 is a diagram showing an image frame divided into a plurality of VOPs complying with the MPEG-4 video coding standard. Referring to FIG. 1, image frame 1 is divided into VOP 0 11 corresponding to the background image, and VOP 1 through 4 13 thrash 19 corresponding respective contents contained in the frame.

FIG. 2 is a block diagram of an MPEG4 encoder. Referring to FIG. 2, the MPEG-4 encoder includes a VOP defining unit 21 which divides an input image into VOP units and outputs the VOPs, a plurality of VOP encoders 23 through 27 which encode respective VOPs, and a multiplexer 29 which multiplexes encoded VOP data to generate a bitstream. The VOP defining unit 21 defines a VOP for each contents in the image frame by using shape information of each contents.

FIG. 3 is a block diagram of an MPEG-4 decoder. Referring to FIG. 3, the MPEG-4 decoder includes a demultiplexing unit 31 which selects a bitstream for each VOP in an input bitstream and demultiplexes the bitstream, a plurality of VOP decoders 33 through 37, which decode bitstreams for respective VOPs, and a VOP synthesizing unit 39.

As described above, since an image is encoded and decoded in units of VOPs in the MPEG-4, contents-based user interaction can be provided to the user.

Meanwhile, image data are generally encoded by an encoder complying with data compression standards such as the MPEG, and then are stored in the form of a bitstream in an information storage medium or transmitted through a communication channel. When images having different spatial resolutions or images having different numbers of reproducing frames per hour, that is, different temporal resolutions, can be reproduced from one bitstream, the bitstream is referred to as ‘scalable’. The former is a spatially scalable case, while the latter is a temporally scalable case.

A scalable bitstream contains base layer data and enhancement layer data. For example, with an application of a spatially-scalable bitstream, a decoder can reproduce the picture quality level of an ordinary TV by decoding the base layer data and if the enhancement layer data are also decoded by using the base layer data, can reproduce an image with the picture quality of a high definition (HD) TV.

The MPEG-4 also supports the scalability unction. That is, scalable encoding can be performed for each VOP unit such that images having different spatial or temporal resolutions can be reproduced in units of VOPs.

Meanwhile, when an image for an ultra-large screen or a multiple-frame image formed with a plurality of frame images is encoded according to the conventional technology, the amount of video data to be transmitted surges. Furthermore, when an image is scalably coded, the amount of video data to be transmitted increases even more and it is difficult to reproduce an image of a high picture quality and show to a user due to the restriction of the bandwidth of a data transmission channel or the limit of the performance of a decoder.

### DISCLOSURE OF INVENTION

### Technical Solution

The present invention provides a video data processing method capable of improving the picture quality of an image of an area-of-interest which a user gazes at in an image being displayed to the user in a situation where there is a restriction of a bandwidth of a data transmission channel or a limit on the performance of a decoder.

The present invention also provides a video data processing apparatus capable of improving the picture quality of an image of an area-of-interest which a user views at in an image being displayed to the user in a situation where there is a restriction of a bandwidth of a data transmission channel or a limit of the performance of a decoder.

### Advantageous Effects

According to the present invention, when a huge amount of video data should be transmitted, and there is a restriction of the bandwidth of a data transmission channel or a limit of the performance of a decoder and it is difficult to reproduce an image with a high picture quality for a user, by using a gaze detection method, the position of an area-of-interest which a user gazes at in a current image being displayed is detected and the area-of-interest is scalably decoded to enhance the picture quality such that the work load to the decoder can be reduced and the bandwidth limit of a data communication channel can be overcome.

### DESCRIPTION OF DRAWINGS

FIG. 1 is a diagram showing an image frame divided into a plurality of video object planes (VOPs).

FIG. 2 is a block diagram showing an example of an MPEG-4 encoder.

FIG. 3 is a block diagram showing an example of an MPEG-4 decoder.

FIG. 4 is a block diagram of a video data processing apparatus according to a preferred embodiment of the present invention.

FIG. 5 is a block diagram showing an example of an area-of-interest determination unit shown in FIG. 4.

FIGS. 6A and 6B are diagrams to explain an example of a gaze detection method.

FIG. 7 is a block diagram showing an example of a decoder shown in FIG. 4.

FIG. 8 is a diagram to explain a process for extracting a bitstream for an individual video object in an input bitstream.

FIG. 9 is a block diagram showing an example of a sub-scalable decoder.

FIGS. 10A and 10B are diagrams showing the achievement of improvements by the present invention of the picture qualities of the digital contents of interest when scalable coding and decoding are performed for respective digital contents.

FIGS. 11A and 11B are diagrams showing achievement of improvements by the present invention of picture qualities of frames of interest when scalable coding and decoding are performed for respective frames.

FIG. 12 is a block diagram of a video data processing apparatus according to another preferred embodiment of the present invention.

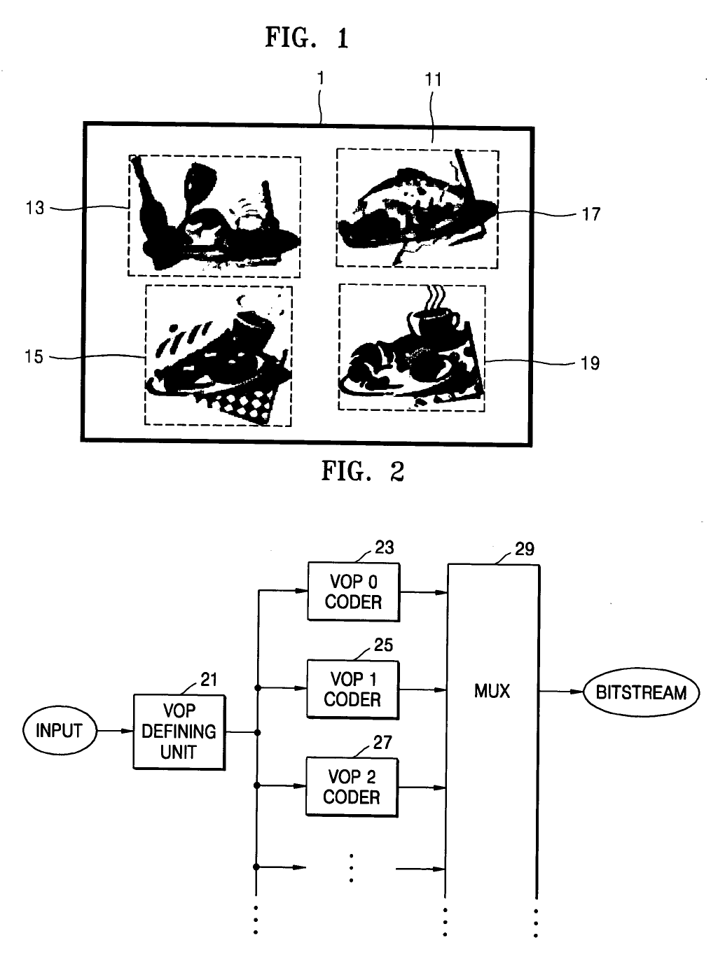

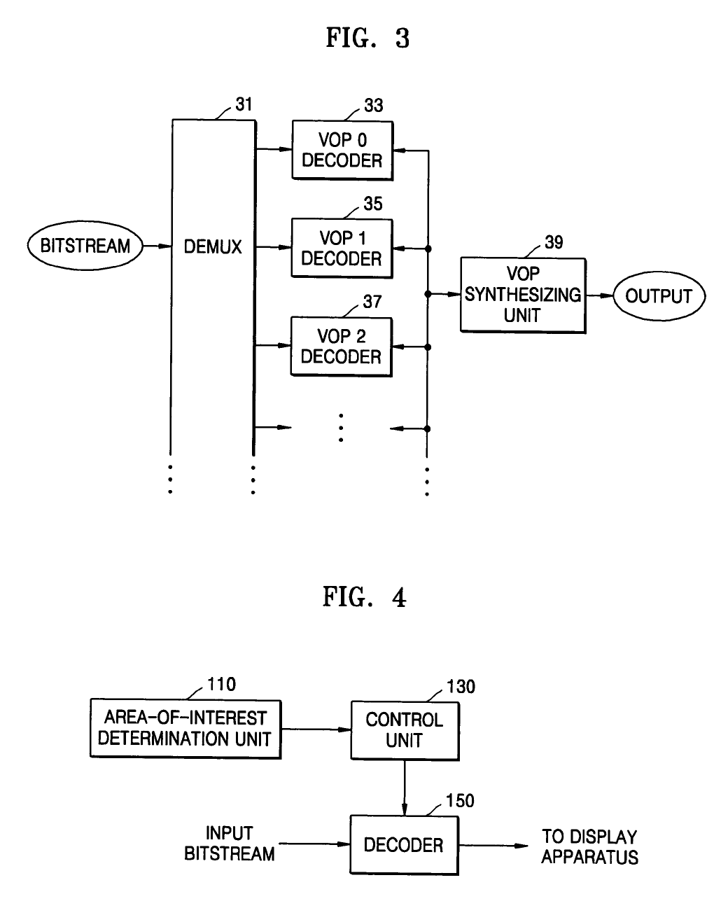

### BEST MODE

According to an aspect of the present invention, there is provided a video processing method including: determining a position of an area-of-interest which a user views at in a current image being displayed, by using gaze detection; selecting a base layer bitstream and enhancement bitstream of a video object containing the area-of-interest in an input bitstream; and scalably decoding the base layer bitstream and the enhancement layer bitstream of the video object.

According to another aspect of the present invention, there is provided a video processing method including: decoding a previous bitstream received from a source apparatus and displaying the bitstream; by using gaze detection, determining the position of an area-of-interest which a user views at in the image being displayed; transmitting the positional information of the area-of-interest to the source apparatus;

receiving from the source apparatus, a current bitstream including base layer bitstream and enhancement bitstream of a video object containing the area-of-interest; and scalably decoding the current bitstream.

According to still another aspect of the present invention, there is provided a video data processing apparatus including: a scalable decoder which scalably decodes an input bitstream; an area-of-interest determination unit which by using gaze detection, determines a position of an area-of-interest which a user views at in a current image being displayed and outputs the positional information of the area-of-interest; and a control unit which according to the positional information received from the area-of-interest determination unit, selects base layer bitstream and enhancement bitstream of a video object containing the area-of-interest in an input bitstream and controls the scalable decoder such that the scalable decoder scalably decodes the selected base layer bitstream and the enhancement layer bitstream.

According to yet still another aspect of the present invention, there is provided a video data processing apparatus including: a scalable decoder which scalably decodes an input bitstream; an area-of-interest determination unit which by using gaze detection, determines the position of an area-of-interest which a user views at in an image that is received from a source apparatus, decoded, and then displayed to a user, and outputs the positional information of the area-of-interest; and a data communication unit which transmits the positional information of the area-of-interest to the source apparatus, in which the scalable decoder decodes a current bitstream which is received from the source apparatus and includes base layer bitstream and enhancement bitstream of a video object containing the area-of-interest.

### Mode for Invention

The present invention will now be described more fully with reference to the accompanying drawings, in which exemplary embodiments of the invention are shown.

In the present invention, the position of an area-of-interest which a user views at in a current image being displayed is detected by using a gaze detection method and by performing scalable decoding, the picture quality of the area-of-interest is enhanced.

The present invention is particularly useful when an image of a large-sized screen with a high spatial resolution, for example, an image displayed by a large-sized display apparatus installed on all four walls of a place, or a multiframe image formed with a plurality of frame images is displayed to a user. This is because when an image with a very high spatial resolution is scalably coded, a huge amount of video data should be transmitted and it is difficult to reproduce an image of a high picture quality and show to a user die to the restriction of the bandwidth of a data transmission channel or the limit of the performance of a decoder.

In order to enhance the picture quality of an area-of-interest, which is detected by using a gaze detection method, by performing scalable decoding, the present invention explains the following two embodiments. In a first embodiment, the position of an area-of-interest which a user gazes at in a current image being displayed is detected by using a gaze detection method, and then, by performing scalable decoding of only a video object containing the area-of-interest, the picture quality of the area-of-interest is enhanced while only base layer decoding is performed for the remaining video objects. That is, the embodiment is to improve the picture quality of an area-of-interest by considering the limit of the performance of a scalable decoder.

In a second embodiment, the position of an area-of-interest which a user gazes at in a current image being displayed is detected by using a gaze detection method, and then, a video data processing apparatus according to the present invention transmits the positional information of the detected area-of-interest to a source apparatus (encoder) which transmits the bitstreams. The source apparatus which receives the positional information of the detected area-of-interest scalably encodes only the video object containing the area-of-interest, and performs only base layer encoding for the remaining video objects such that the amount of data to be transmitted thrash the communication channel is greatly reduced. That is, the second embodiment is to improve the picture quality of an area-of-interest by considering the limit of the bandwidth of a data communication channel.

As a data communication channel, a variety of transmission media such as a PSTN, an ISDN, the Internet, an ATM network, and a wireless communication network can be used.

Here, when an image is a multiple-frame image, a video object indicates one frame, while when one frame image is divided and coded by image contents contained in the frame image as in the MPEG-4, a video object indicates each of the image contents (that is, a VOP).

The two preferred embodiments of the present invention mentioned above will now be explained in more detail with reference to attached figures.

### I. FIRST EMBODIMENT

FIG. 4 is a block diagram of a video data processing apparatus according to a first preferred embodiment of the present invention. Referring to FIG. 4, the video processing apparatus includes an area-of-interest determination unit 110, a control unit 120, and a decoder 150.

The area-of-interest determination unit 110 determines the position of an area-of-interest which a user gazes at in a current image being displayed to the user thrash a display apparatus (not shown), by using gaze detection, and outputs the positional information of the area-of-interest to the control unit 130.

The control unit 130, according to the positional information of the area-of-interest input from the area-of-interest determination unit 110, controls the decoder 150 so that the decoder 150 selects the base layer bitstream and enhancement layer bitstream of a video object containing the area-of-interest in an input bitstream, and scalably decodes the selected base layer bitstream and enhancement layer bitstream.

The decoder 150 is a scalable decoder which performs scalable decoding of an input bitstream according to the control of the control unit 130.

According to the control of the control unit 130, the decoder 150 selects the enhancement layer bitstream of the video object containing the area-of-interest which the user gazes at in the input bitstream and performs scalable decoding such that the picture quality of the area-of-interest is enhanced. In addition, according to the control of the control unit 130, the decoder 150 does not perform decoding of the enhancement layer bitstream of the other video objects than the video object containing the area-of-interest, but decodes only the base layer data such that the load to the decoder 150 is reduced.

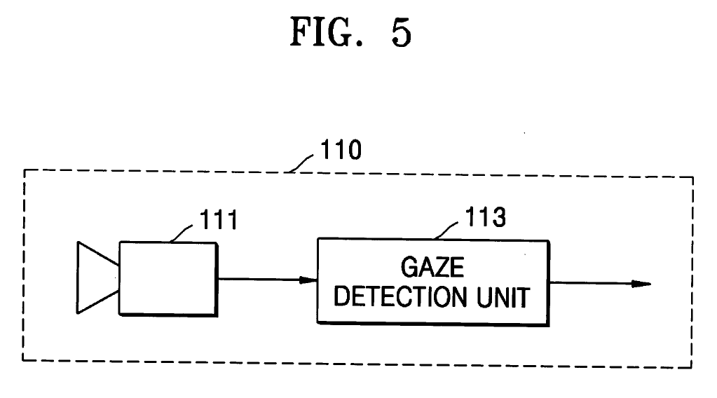

FIG. 5 is a block diagram showing an example of the area-of-interest determination unit 110 shown in FIG. 4. Referring to FIG. 5, the area-of-interest determination unit 110 includes a video camera 111 which takes images of a user focusing on the head part of a subject, and a gaze detection unit 113 which determines the position of an area-of-interest which the user gazes at in a current image, by analyzing the moving pictures of the user input through the video camera 111.

The gaze detection is a method to detect a position which a user gazes at, by estimating the motion of the head and/or eyes of the user. There are a variety of embodiments. Korean Patent Laying-Open Gazette No. 2000-0056563 discloses an embodiment of a gaze detection method.

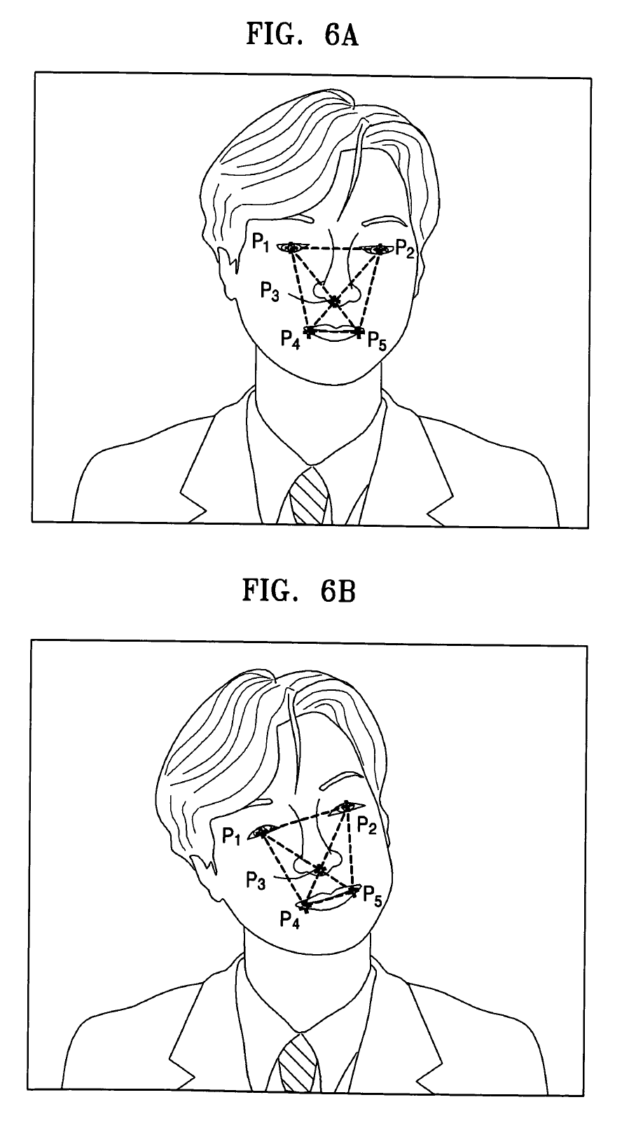

FIGS. 6A and 6B are diagrams to explain the example of a gaze detection method disclosed by the Korean Patent Laying-Open Gazette. A user recognizes information of a specific part in a scene displayed on a display apparatus, for example, a monitor, by moving mainly the eyes or the head. Considering this, by analyzing image information on the user photographed through the video camera installed on the monitor or on a place where it is convenient to record images of the head of the user, the position on a monitor which the user gazes at is detected.

FIG. 6A shows the positions of the two eyes, nose, and mouth of the user when the user gazes at the screen of the display apparatus. Points P1 and P2 indicate the positions of the two eyes, P3 indicates the position of the nose, and P4 and P5 indicate the positions of the corners of the mouth.

FIG. 6B shows the positions of the two eyes, nose, and mouth of the user when the user moves the head and gazes in a direction other than the screen of the monitor.

Likewise, points P1 and P2 indicate the positions of the two eyes, P3 indicates the position of the nose, and P4 and P5 indicate the positions of the corners of the mouth. Accordingly, by sensing changes in the five different positions, the gaze detection unit 113 can detect the position on the monitor which the user gazes at.

The gaze detection method according to the present invention is not limited to the embodiment described above, and can be any gaze detection method. Also, the area-of-interest determination unit 110 according to the present invention can be implemented in a variety of forms. For example, it can be made as a small-sized camera capable taking photos of a user, or as a helmet, goggles, or glasses in which an apparatus capable of sensing motions of the head is installed. When a user wears a special device in the form of a helmet having a gaze detection function, the special device senses the position of an area-of-interest which the user gazes at and then, transmits the positional information of the sensed area-of-interest to the control unit 130 thrash a wire or wirelessly. Special devices such as a helmet with a gaze detection function are already commercially provided. For example, pilots of military helicopters wear helmets with a gaze detection function to calibrate machine guns.

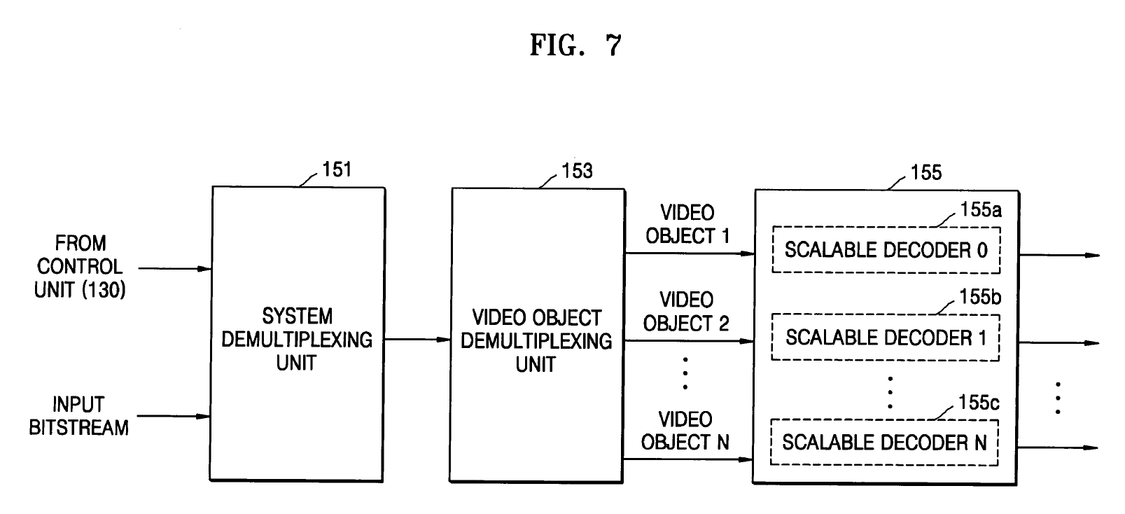

FIG. 7 is a block diagram showing an example of the decoder 150 shown in FIG. 4. Referring to FIG. 7, the decoder 150 includes a system demultiplexing unit 151, a video object demultiplexing unit 153, and a scalable decoder 155. The scalable decoder 155 includes a plurality of sub-scalable decoders 155A through 155C, each performing scalable decoding in units of video objects.

The system demnltiplexing unit 151 demultiplexes an input bit stream into a system bitstream, a video stream and an audio stream and outputs the demultiplexes streams.

In particular, according to the control of the control unit 130, the system demultiplexing unit 151 selects the base layer bitstream and enhancement layer bitstream of a video object containing an area-of-interest which the user gazes at in the input bitstream, and the base layer bitstreams of the other video objects that do not include the area-of-interest, and outputs the selected bitstream to the video object demultiplexing unit 153. That is, the enhancement layer bitstream of the other video objects that do not include the area-of-interest are not output to the video object demultiplexing unit 153 such that the bitstreams are not decoded.

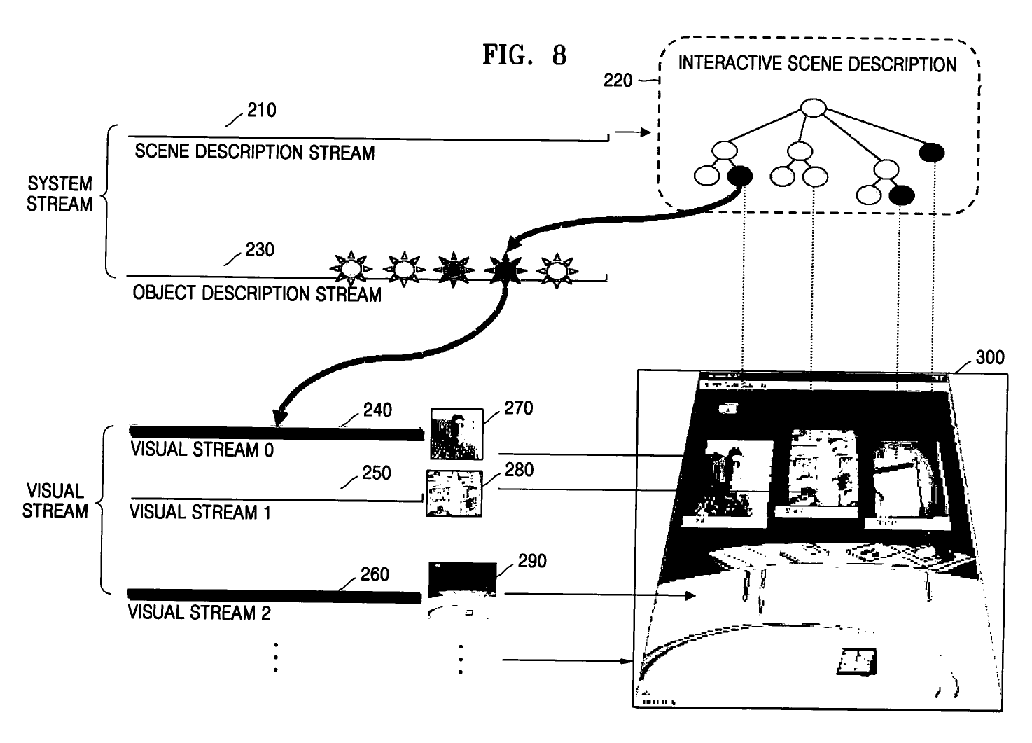

FIG. 8 is a diagram to illustrate a process for extracting a bitstream for an individual video object in an input bitstream.

When the input bitstream is generated complying with the MPEG-4 part 2 specification, the input bitstream includes system bitstreams such as a scene description stream 210 and an object description stream 230. The scene description stream 210 is a bitstream containing an interactive scene description 220 explaining one video structure, and the interactive scene description 220 has a tree structure.

The interactive scene description 220 includes positional information of VOP 0 270, VOP 1 280, and VOP 2 290 included in one image 300, and audio data information and video data information of each VOP. The object description stream 230 includes positional information of the audio bitstream and video bitstream of each VOP.

Referring to FIG. 8, the video object, that is, a VOP containing the area-of-interest which the user gazes at, is VOP 0 270.

According to the control of the control unit 130, the system demultiplexing unit 151 compares the positional information of the area-of-interest input from the area-of-interest determination unit 110, with information included in the scene description stream 210 and the object description stream 230 included in the input bitstream. Then, the system demultiplexing unit 151 selects/extracts the visual stream 240 containing the base layer bitstream and enhancement layer bitstream of the VOP 0 270 which the user gazes at in the input bitstream, and selects/extracts only base layer bitstreams 250 and 260 of the remaining video objects that do not include the area-of-interest, and then outputs the selected bitstreams to the video object demultiplexing unit 153.

The video object demultiplexing unit 153 demultiplexes bitstreams of respective video objects included in the bitstream and outputs the bitstream of each video object to a corresponding sub-scalable decoder 155A through 155C of the scalable decoder 155.

If video object 0 is the video object containing the area-of-interest, the base layer bitstream and enhancement layer bitstream of video object 0 are input to the sub-scalable decoder 155A, and the sub-scalable decoder 0 155A performs scalable decoding. Accordingly, video object 0 is reproduced as a high quality image. To the other sub-scalable decoders 155B and 155C, only the base layer bitstreams of respective video objects and only base layer decoding is performed such that images of a low picture quality are reproduced.

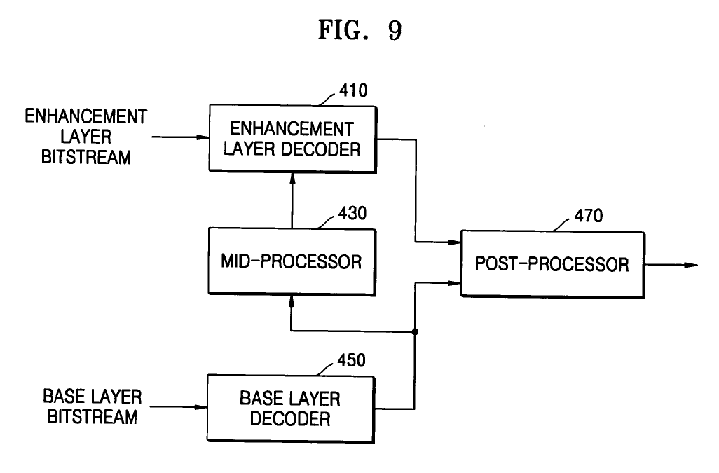

FIG. 9 is a block diagram showing an example of a sub-scalable decoder. Referring to FIG. 9, the sub-scalable decoder includes an enhancement layer decoder 410, a mid-processor 430, a base layer decoder 450, and a post-processor 470.

The base layer decoder 450 receives the base layer bitstream and performs base layer decoding. The enhancement layer decoder 410 performs enhancement layer decoding with the enhancement layer bitstream and the base layer bitstream input from the mid-processor 430. If the base layer bitstream is a bitstream spatially scalably encoded by an encoder, the mid-processor 430 increases the spatial resolution by up-sampling the base layer data which is base layer decoded, and then provides to the enhancement layer decoder 410. The post-processor 470 receives decoded base layer data and enhancement layer data from the base layer decoder 450 and the enhancement layer decoder 410, respectively, and combines the two data inputs, and then performs signal processing, such as smoothing.

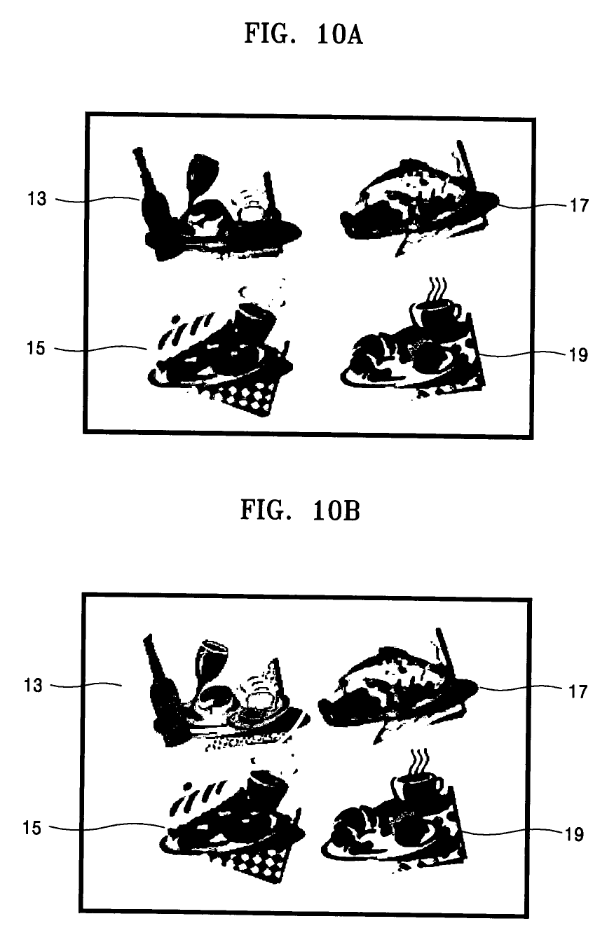

FIGS. 10A and 10B are diagrams showing achievement of improvements by the present invention of the picture qualities of the digital contents of interest when scalable coding and decoding are performed for respective digital contents.

FIG. 10A shows an image containing a plurality of contents 13 through 18 reproduced according to the conventional technology. In the conventional technology, the scalable bitstream cannot be transmitted die to the restriction of the bandwidth of a data transmission channel or the limit of the performance of a decoder, or even though the scalable bitstream is received, a lower quality image is reproduced die to the limit on the performance of a decoder.

FIG. 10B shows a reproduced image in which the picture quality of an area-of-interest which the user gazes at is improved according to the present invention. In the present invention, by using a gaze detection method, the position of an area-of-interest which the user gazes at is detected in a current image being displayed, and then only the video object 13 containing the area-of-interest is scalably decoded to improve the picture quality of the area-of-interest, and only base layer data are decoded in the other video objects 15 through 18.

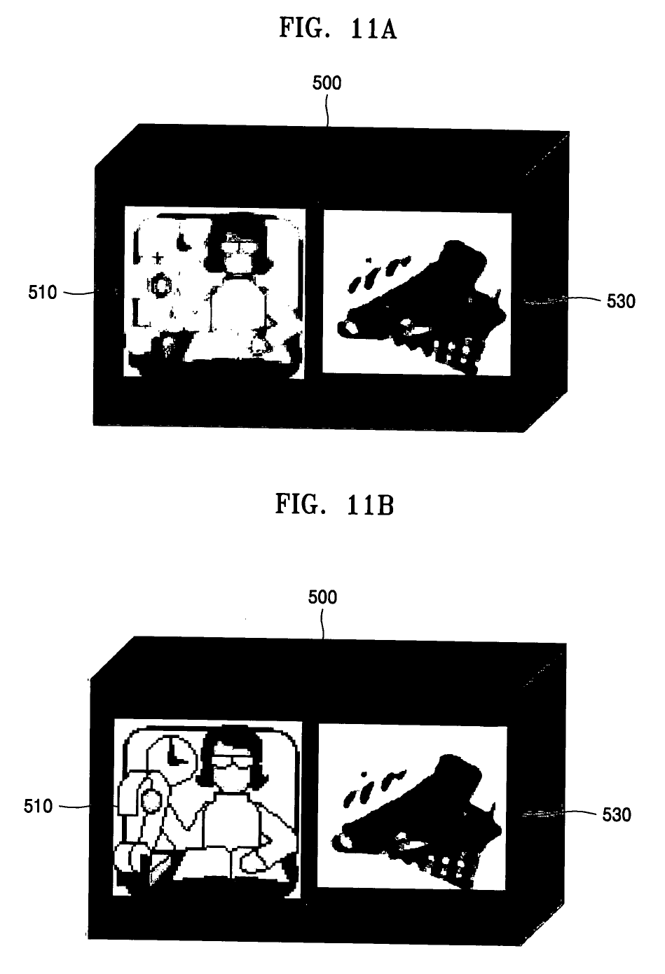

FIGS. 11A and 11B are diagrams showing achievement of improvements by the present invention of picture qualities of frames of interest when scalable coding and decoding are performed for respective frames in a multiframe image. Referring to FIGS. 11A and 11B, a multiframe image containing a plurality of images 510 and 530 is displayed through a display apparatus 500.

FIG. 11A shows a multiframe image containing frame images 510 and 530 reproduced according to conventional technology. Due to the restriction of a data transmission channel or the limit on the performance of a decoder, the scalable bitstream cannot be transmitted or even through the scalable bitstream is received, a lower quality multiframe image is reproduced die to the limit on the performance of a decoder.

FIG. 11B shows a reproduced image in which the picture quality of an area-of-interest which the user gazes at is improved according to the present invention. In the present invention, by using a gaze detection method, the position of an area-of-interest which the user gazes at is detected in a current multiframe image being displayed, and then only the frame image 510 containing the area-of-interest is scalably decoded to improve the picture quality of the area-of-interest, and only base layer data are decoded in the other frame image 530.

### II. SECOND EMBODIMENT

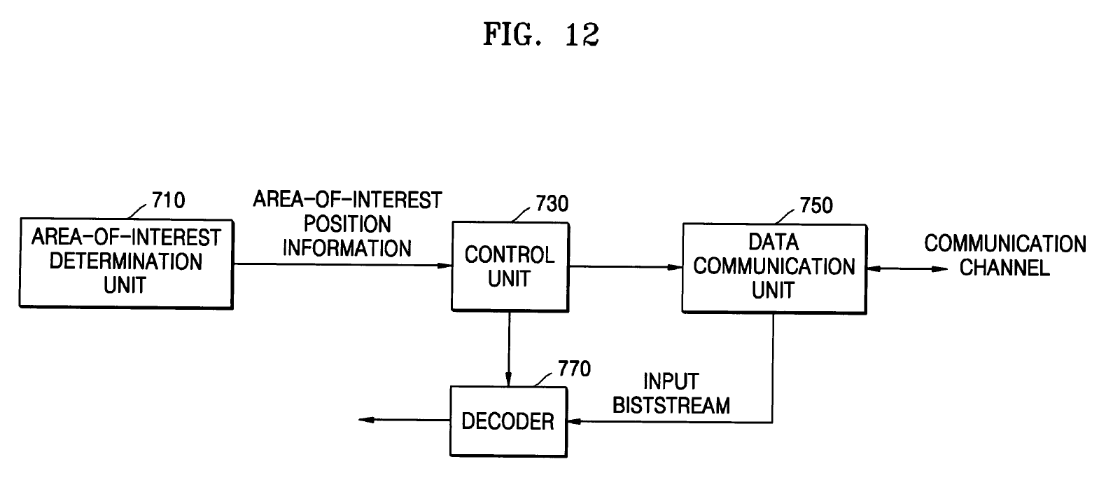

FIG. 12 is a block diagram of a video data processing apparatus according to another preferred embodiment of the present invention. Referring to FIG. 12, the video data processing apparatus includes an area-of-interest determination unit 710, a control unit 730, a data communication unit 750, and a decoder 770.

According to the second embodiment of the present invention, by using the gaze detection method as described above, the position of an area-of-interest which the user gazes at in the current image being displayed is detected by the area-of-interest determination unit 710. The control unit 730 controls the data communication unit 750 such that the positional information of the area-of-interest detected by the area-of-interest determination unit 710 is transmitted to the source apparatus (encode, not shown) which transmits a bitstream to the video data processing unit according to the second preferred embodiment of the present invention.

Receiving the positional information of the detected area-of-interest, the source apparatus scalably encodes only a video object containing the area-of-interest and base layer encodes the other video objects such that the amount of data to be transmitted through the communication channel is greatly reduced. That is, considering the restriction of the bandwidth of the data transmission channel, the picture quality of the area-of-interest is greatly enhanced.

The bitstream received through the data communication unit 750 is input to the decoder 770. The decoder 770 scalably decodes the input bitstream according to the control of the control unit 730.

The decoder 770 does not need to distingish enhancement layer bitstreams of the video object containing the area-of-interest which the user gazes at and the remaining video objects, unlike the decoder 150 in the first embodiment described above. This is because only the video object containing the area-of-interest is scalably encoded by the source apparatus such that only the video object containing the area-of-interest includes the enhancement layer bitstream in the input bitstream.

Meanwhile, as a data communication channel, a variety of transmission media such as a PSTN, an ISDN, the Internet, an ATM network, and a wireless communication network can be used.

When the transmission speed of a data communication channel is lowered, by using a method, for example, which increases the quantization coefficient values when data are encoded in the source apparatus, the base layer data can be degraded and the amount of transmission data can be reduced.

In addition, the data processing apparatus according to the present invention can be applied to a bidirectional video communication system, a unidirectional video communication system, or multiple bidirectional video communication system.

As examples of the bidirectional video communication system, there are a bidirectional video teleconferencing and a bidirectional broadcasting system. As examples of the unidirectional video communication system, a unidirectional Internet broadcasting such as home-shopping broadcasting, and a surveillance system such as a parking lot monitoring system. As an example of the multiple bidirectional video communication system, there is a teleconference system among multiple persons. The second embodiment of the present invention is for only bidirectional application, not for unidirectional application.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission thrash the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A video processing method comprising:
determining a position of an area-of-interest which a user gazes at in a current image being displayed, by using gaze detection;
selecting a base layer bitstream and enhancement bitstream of a video object containing the area-of-interest in an input bitstream; and
scalably decoding the base layer bitstream and the enhancement layer bitstream of the video object.

2. The method of claim 1, wherein the input bitstream is a scalable bitstream in which each of a plurality of video objects is scalably coded.

3. The method of claim 1, wherein the gaze detection is to determine the position of the area-of-interest by estimating motion of a head or eyes of the user.

4. The method of claim 2, wherein the input bitstream includes positional information of the plurality of video objects included in each image, and in selecting the bitstreams, the positional information of the area-of-interest is compared with the positional information of the plurality of video objects included in the input bitstream, and the base layer bitstream and enhancement layer bitstream of the video object containing the area-of-interest are selected.

5. The method of claim 2, further comprising:
selecting the enhancement layer bitstream of the remaining video objects except the video object containing the area-of-interest in the input bitstream; and
discarding the selected enhancement layer bitstream of the remaining video objects not to be decoded.

6. The method of claim 1, wherein the video object is one frame when the input image is a multiframe image, and is a video content when one frame image is divided into a plurality of video contents.

7. A video data processing apparatus comprising:
a scalable decoder which scalably decodes an input bitstream;
an area-of-interest determination unit which by using gaze detection, determines a position of an area-of-interest which a user gazes at in a current image being displayed and outputs the positional information of the area-of-interest; and
a control unit which according to the positional information received from the area-of-interest determination unit, selects a base layer bitstream and enhancement bitstream of a video object containing the area-of-interest in an input bitstream and controls the scalable decoder such that the scalable decoder scalably decodes the selected base layer bitstream and the enhancement layer bitstream.

8. The apparatus of claim 7, wherein the input bitstream is a scalable bitstream in which each of a plurality of video objects is scalably coded.

9. The apparatus of claim 7, wherein the gaze detection is to determine the position of the area-of-interest by estimating motion of a head or eyes of the user.

10. The apparatus of claim 8, wherein the input bitstream includes positional information of the plurality of video objects included in each image, and the control unit compares the positional information of the area-of-interest with the positional information of the plurality of video objects included in the input bitstream, and selects the base layer bitstream and enhancement layer bitstream of the video object containing the area-of-interest are selected.

11. The apparatus of claim 8, wherein the control unit selects the enhancement layer bitstream of the remaining video objects except the video object containing the area-of-interest in the input bitstream and controls the scalable decoder such that the scalable decoder does not decode the selected enhancement layer bitstream of the remaining video objects.

12. The apparatus of claim 7, wherein the video object is one frame when the input image is a multiframe image, and is a video content when one frame image is divided into a plurality of video contents.

13. A video processing method comprising:
decoding a previous bitstream received from a source apparatus and displaying the bitstream;
by using gaze detection, determining the position of an area-of-interest which a user gazes at in the image being displayed;
transmitting the positional information of the area-of-interest to the source apparatus;
receiving from the source apparatus, a current bitstream including a base layer bitstream and enhancement bitstream of a video object containing the area-of-interest; and
scalably decoding the current bitstream.

14. The method of claim 13, wherein the current bitstream is a bitstream in which only the video object containing the area-of-interest is scalably coded among a plurality of video object included in one image.

15. The method of claim 13, wherein the gaze detection is to determine the position of the area-of-interest by estimating motion of a head or eyes of the user.

16. The method of claim 13, wherein the video object is one frame when the input image is a multiframe image, and is a video content when one frame image is divided into a plurality of video contents.

17. A video data processing apparatus comprising:
a scalable decoder which scalably decodes an input bitstream;
an area-of-interest determination unit which by using gaze detection, determines the position of an area-of-interest which a user gazes at in an image that is received from a source apparatus, decoded, and then displayed to a user, and outputs the positional information of the area-of-interest; and
a data communication unit which transmits the positional information of the area-of-interest to the source apparatus, wherein the scalable decoder decodes a current bitstream which is received from the source apparatus and includes base layer bitstream and enhancement bitstream of a video object containing the area-of-interest.

18. The apparatus of claim 17, wherein the current bitstream is a bitstream in which only the video object containing the area-of-interest is scalably coded among a plurality of video object included in one image.

19. The apparatus of claim 17, wherein the gaze detection is to determine the position of the area-of-interest by estimating motion of a head or eyes of the user.

20. The apparatus of claim 17, wherein the video object is one frame when the input image is a multiframe image, and is a video content when one frame image is divided into a plurality of video contents.

21. A computer readable recording medium having embodied thereon a computer program for video data processing method, where in the video processing method comprises:
determining a position of an area-of-interest which a user gazes at in a current image being displayed, by using gaze detection;
selecting a base layer bitstream and enhancement bitstream of a video object containing the area-of-interest in an input bitstream; and
scalably decoding the base layer bitstream and the enhancement layer bitstream of the video object.

22. A computer readable recording median having embodied thereon a computer program for video data processing method, where in the video processing method comprises:
decoding a previous bitstream received from a source apparatus and displaying the bitstream;
by using gaze detection, determining the position of an area-of-interest which a user gazes at in the image being displayed;
transmitting the positional information of the area-of-interest to the source apparatus;
receiving from the source apparatus, a current bitstream including base layer bitstream and enhancement bitstream of a video object containing the area-of-interest; and
scalably decoding the current bitstream.
